(19) United States
(12) Patent Application Publication
(10) Pub. No.: US 2008/0174190 A1
(43) Pub. Date: Jul. 24, 2008

(54) ROTATING ELECTRICAL MACHINE

(75) Inventors: Fumito KURATA, Nishikamo-gun (JP); Koichi Ikeda, Okazaki-shi (JP); Toshiyuki Kobayashi, Nishikamo-gun (JP); Takeshi Ishida, Aichi-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/970,790

(22) Filed: Jan. 8, 2008

(30) Foreign Application Priority Data
Jan. 18, 2007 (JP) 2007-009528

(51) Int. Cl. H02K 9/19

(52) U.S. Cl. 310/54

(57) ABSTRACT

A rotating electrical machine that includes a rotor, a stator, and an encasing member that encases the rotor and the stator is also provided with a guide member that guides coolant which cools the rotating electrical machine into a gap between the stator and the encasing member.

### INCORPORATION BY REFERENCE

The disclosure of Japanese Patent Application No. 2007-009528 filed on Jan. 18, 2007, including the specification, drawings and abstract is incorporated herein by reference in its entirety.

### BACKGROUND OF THE INVENTION

1. Field of the Invention

The invention relates to a rotating electrical machine that may be applied to a vehicle such as a passenger car, a bus, or a truck or the like.

2. Description of the Related Art

Japanese Patent Application Publication No. 2006-166554 (JP-A-2006-166554), for example, describes a wheel assembly provided with an in-wheel motor that has a motor and a reduction mechanism for each wheel. This motor assembly rearranges the motor, which serves as a driving source, from inside the vehicle to the inner peripheral side of a wheel which forms part of the wheel assembly in attempt to effectively utilize the space inside the vehicle, effectively utilize excess space on the inner peripheral side of the wheel, lower the floor of the vehicle, omit driving force transmitting apparatuses such as the drive shaft and the differential gear, finely control the speed and torque of each wheel assembly, and control vehicle posture, and the like.

This kind of wheel assembly with an in-wheel motor has a knuckle that forms part of a normal suspension apparatus and rotatably supports the wheel assembly. The knuckle is positioned on the wheel assembly side of a spring or shock absorber that makes up the suspension apparatus and thus directly (i.e., not via the spring or shock absorber) receives force input to the tire that forms part of the wheel assembly from the ground during driving, braking, turning, or riding over rough road or the like. As a result, the force exerted on the in-wheel motor, i.e., the rotating electrical machine, that is used in the wheel assembly is relatively greater than the force exerted on a rotating electrical machine that is arranged in the vehicle.

The rotating electrical machine is cooled by supplying coolant that also serves as a lubricant in the gap between the stator and the housing that form part of the rotating electrical machine. However, as described above, in the rotating electrical machine that is applied to a wheel assembly with an in-wheel motor, more force is exerted on the rotating electrical machine which makes the housing prone to deforming and the stator prone to moving relative to the housing. Therefore, the width of the gap between the stator and the housing is not constant which makes it difficult to have a uniform amount of coolant flow through the gap as a whole. As a result, good cooling performance is unable to be ensured. Furthermore, interference between the housing and the stator may also adversely affect motor performance.

### SUMMARY OF THE INVENTION

This invention thus provides a rotating electrical machine that is able to ensure better cooling performance and prevent interference between the housing and the stator.

In order to solve the foregoing problems, a rotating electrical machine according to one aspect of the invention is provided with a rotor, a stator, an encasing member that encases the rotor and the stator, and also includes a guide member that guides coolant which cools the rotating electrical machine into a gap between the stator and the encasing member.

Incidentally, the rotating electrical machine is not limited to a motor, i.e., it may also be a generator or a velocity generator, as long as it is provided with a rotor, a stator, and an encasing member that encases the rotor and the stator. The encasing member refers to a housing.

In the rotating electrical machine according to this aspect, the guide member may also be formed of an elastic porous body. One typical example of this elastic porous body is sponge material.

According to this structure, even if a large force is exerted on the rotating electrical machine such that the encasing member greatly deforms and the gap between the stator and the encasing member is not constant, the elastic porous body enables coolant to be uniformly guided into the gap between the stator and the encasing member, thus enabling the rotating electrical machine to be uniformly cooled. As a result, good cooling performance can be ensured. Incidentally, the gap between the stator and the encasing member may refer to a gap in one or both of the axial direction and the radial direction.

Alternatively, in the rotating electrical machine, the guide member may be formed of a flocked member. A typical example of this flocked member is a sheet of synthetic resin on which hairs of synthetic resin are provided like a brush.

Alternatively, in the rotating electrical machine, the guide member may be formed of a synthetic resin body having a groove portion. Incidentally, for example, the guide member, i.e., the synthetic resin body, may be integrally formed with the outer peripheral surface of the stator by mold casting and have groove portions for guiding coolant formed in its surface opposing the encasing member, as well as wall portions which define those groove portions. The synthetic resin body and the stator are inserted into the encasing member.

Further, the rotating electrical machine may also be provided with a storing portion in which the coolant is stored, and a portion of the elastic porous body may extend into the storing portion. A typical example of the storing portion is a reservoir provided in the encasing member.

The invention makes it possible to provide a rotating electrical machine that is able to ensure better cooling performance and prevent interference between the housing and the stator.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a sectional view of an in-wheel motor assembly to which a motor according to a first example embodiment of the invention has been applied;

FIG. 2 is a sectional view of an in-wheel motor assembly to which a motor according to a modified example of the first example embodiment of the invention has been applied;

FIG. 3 is a sectional view of an in-wheel motor assembly to which a motor according to a second example embodiment of the invention has been applied;

FIG. 4 is a sectional view of an in-wheel motor assembly to which a motor according to a third example embodiment of the invention has been applied;

FIG. 5 is a sectional view of an in-wheel motor assembly to which a motor according to a fourth example embodiment of the invention has been applied; and

FIG. 6 is a view of a guide member of the in-wheel motor shown in FIG. 5.

### DETAILED DESCRIPTION OF THE EMBODIMENTS

In the following description and the accompanying drawings, the present invention will be described in more detail in terms of example embodiments.

### First Example Embodiment

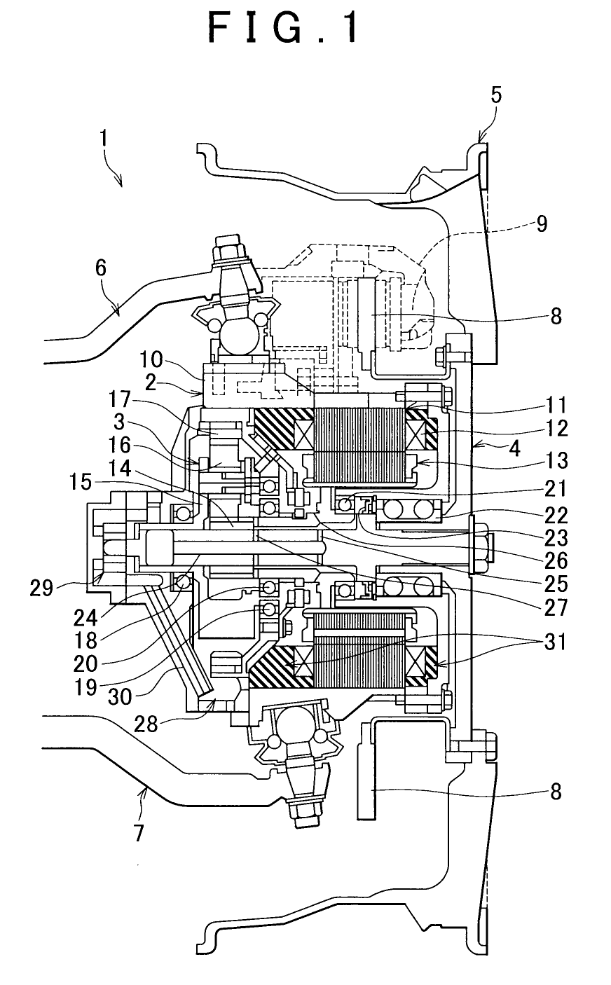

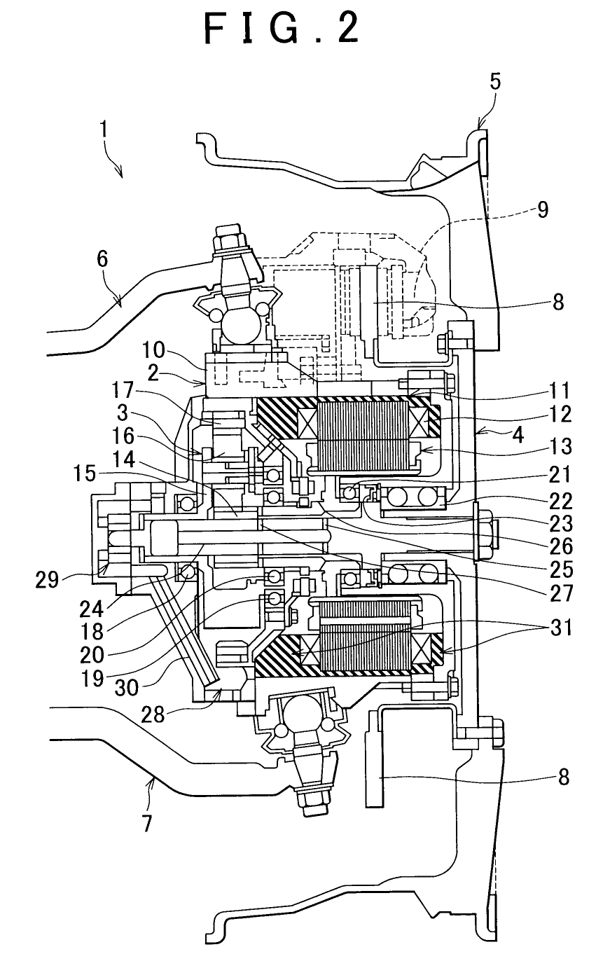

FIG. 1 is a sectional view of an in-wheel motor assembly to which a motor according to a first example embodiment of the invention has been applied, and FIG. 2 is a sectional view of an in-wheel motor assembly to which a motor according to a modified example of the first example embodiment of the invention has been applied. These sectional views include the center axis of the motor.

An in-wheel motor assembly 1 includes a motor 2, a reduction mechanism 3, an output shaft 4, a wheel 5, an upper arm 6, a lower arm 7, a brake disc rotor 8, and a caliper brake 9. The motor 2 and the reduction mechanism 3 are provided in positions on the inner peripheral side of the cylindrical wheel 5. The motor 2 is an in-wheel motor.

The motor 2 is a synchronous motor, i.e., a rotating electrical machine, that includes a housing 10, a stator 11, a coil 12, and a rotor 13. The motor 2 is driven by an inverter, not shown. The housing 10 is made of aluminum alloy and forms an encasing member that retains the outer peripheral surface of the stator 11 and encases the stator 11, the coil 12, the rotor 13, and the reduction mechanism 13.

The upper arm 6 is an A arm that extends in the vehicle width direction. The outer side of the upper arm 6 in the vehicle width direction is connected to an upper portion of the housing 10 via a ball joint. The inner side of the upper arm 6 in the width vehicle direction is connected to a suspension member on the vehicle body side, not shown.

Similarly, the lower arm 7 is an A arm that also extends in the vehicle width direction. The outer side of the lower arm 7 in the vehicle width direction is connected to an lower portion of the housing 10 via a ball joint. The inner side of the lower arm 7 in the width vehicle direction is connected to a suspension member on the vehicle body side, not shown.

A portion in the middle of the lower arm 7 in the vehicle width direction is connected to a lower end portion of a cylinder of a shock absorber, not shown. A rod of the shock absorber is connected to the vehicle body side via a bush. A coil spring, not shown, is provided on the outer peripheral side of the rod of the shock absorber.

The stator 11 includes a stator core that is formed of magnetic steel sheets that are laminated together and a coil 12 wound around a plurality of teeth formed on the inner peripheral side of the stator core. The rotor 13 is formed of a rotor core, which is formed of magnetic steel sheets that are laminated together, having permanent magnets, not shown, embedded therein.

In the motor 2 having this kind of structure, a rotating magnetic field is created when three-phase alternating current is supplied to the coil 12 provided in the stator 11 by the inverter. The rotor 13, which is provided with the permanent magnets, is drawn toward the rotating magnetic field such that it rotates.

The reduction mechanism 3 is a well-known planetary gear set formed of a sun gear 14, a carrier 15, pinions 16, and a ring gear 17. The portion of the sun gear 14 on the inner peripheral side extends cylindrically to the outside in the vehicle width direction. The end portion of the sun gear 14 on the outside in the vehicle width direction is joined to the inner peripheral side portion of the rotor 13. The inner peripheral side portion of the carrier 15 extends cylindrically to the inside in the vehicle width direction. The outer peripheral surface of the end portion of the carrier 15 that is on inside in the vehicle width direction abuts against the housing 10.

The inside of the carrier 15 in the vehicle width direction is rotatably supported with respect to the housing 10 by a carrier inner bearing 18. The outside of the carrier 15 in the vehicle width direction is rotatably supported with respect to the housing 10 by a carrier outer bearing 19. A sun gear bearing 20 is interposed between the sun gear 14 and the outside of the carrier 15 in the vehicle width direction. This sun gear bearing 20 rotatably supports the carrier 15 relative to the sun gear 14.

The rotor 13 is rotatably supported with respect to the housing 10 by a rotor bearing 21, and the output shaft 4 is rotatably supported with respect to the housing 10 by an output shaft bearing 22. An oil seal 23 is provided adjacent to the inside of the output shaft bearing 22 in the vehicle width direction between the output shaft 4 and the housing 10.

The outside portion of the output shaft 4 in the vehicle width direction is disc-shaped with a larger diameter than the housing 10. The outer peripheral side portion of this disc-shaped portion is fastened by a bolt to the inner peripheral side portion of the wheel 5. Also, the brake disc rotor 8 is fastened by a bolt to the inner side in the vehicle width direction of the outer peripheral side portion of the disc-shaped portion of the output shaft 4.

A bead portion of a tire, not shown, is mounted to a bead seat portion of the wheel 5 and the space defined by the outer peripheral surface of the wheel 5 and the inner peripheral surface of the tire is filled with air to a predetermined pneumatic pressure.

The base portion of the caliper brake 9 is fixed to the housing 10 and brake pads of the caliper brake 9 are arranged facing both sides of the brake disc rotor 8.

According to the this structure, when the motor 2 is driven by the inverter, not shown, the driving force of the motor 2 is transmitted to the rotor 13, the sun gear 14, the pinions 16, the carrier 15, the output shaft 4, and the wheel 5 in turn at a predetermined reduction gear ratio of the reduction mechanism 3. The driving force is then transmitted to the ground by the tire, not shown, so as to drive the vehicle.

A shaft center passage 24 which extends in the axial direction is drilled in a portion of the output shaft 4 that is on the side on which the sun gear 14 is provided. A supply passage 25 which supplies coolant that also acts as a lubricant to a space formed between the housing 10 and the inside of the stator 11 in the vehicle width direction is drilled in the output shaft 4 so as to extend from the end portion of the shaft center passage 24 that is on the outside in the vehicle width direction to the outer peripheral surface of the output shaft 4. Furthermore, a supply passage 26 that supplies coolant coming from the supply passage 25 to the space formed between the housing 10 and the inside of the stator 11 in the vehicle width direction is provided in a portion where the sun gear 14 joins the inner peripheral side portion of the rotor 13.

In addition, a supply passage 27 that supplies coolant to the reduction mechanism 3 is drilled in the output shaft 4 so as to extend from the shaft center passage 24 to the outer peripheral surface of the output shaft 4 at a position to the inside of the sun gear bearing 20 in the vehicle width direction. Also, the rotor bearing 21 is a non-sealed bearing which has no oil seal and thus forms a supply passage that supplies coolant coming from the supply passage 25 to a space formed between the housing 10 and the outside of the stator 11 in the vehicle width direction.

A reservoir 28 that forms a storing portion for storing coolant is formed in the lower portion of the housing 10. An internal gear pump 29 is provided on the inside end of the output shaft 4 in the vehicle width direction. Further, a connecting passage 30 that connects the reservoir 28 with the pump 29 is provided in the housing 10.

With this kind of structure, when the motor 2 is driven by the inverter, not shown, the output shaft 4 rotates at the predetermined reduction gear speed of the reduction mechanism 3. This rotational force drives the pump 29 which then supplies coolant from the reservoir 28 through the connecting passage 30 to the shaft center passage 24. The coolant supplied to the shaft center passage 24 is first supplied by the centrifugal force of the output shaft 4 to the space formed between the housing 10 and the inside in the vehicle width direction of the stator 11 through the supply passage 25 and the supply passage 26. Then the coolant is supplied to the gap in the radial direction between the housing 10 and the stator 11 to mainly cool the stator 11, after which it is supplied to the gap in the radial direction between the stator and the rotor 13 to mainly cool the stator 11 and the rotor 13.

Moreover, the centrifugal force of the output shaft 4 causes the coolant supplied to the shaft center passage 24 to flow through the supply passage 25 and the rotor bearing 21 into the space formed between the housing 10 and the outside of the stator 11 in the vehicle width direction. Moreover, this coolant is supplied to the gap in the radial direction between the housing 10 and the stator 11 to mainly cool the stator 11, after which it is supplied to the gap in the radial direction between the stator and the rotor 13 to mainly cool the stator 11 and the rotor 13.

In addition, the centrifugal force of the output shaft 4 also causes the coolant supplied to the shaft center passage 24 to flow through the supply passage 27 to the sun gear 14, the carrier 15, the pinions 16, and the ring gear 17 which form the reduction mechanism 3. As a result, the coolant cools these gears and also works as a lubricant to suppress friction between them.

In this way, the coolant that is supplied to the gap between the housing 10 and the stator 11, between the rotor 13 and the stator 11, and the reduction mechanism 3 returns again by gravity to the reservoir 28 from which it is again drawn up by the pump 29 and supplied to the shaft center passage 24. As the coolant circulates inside the housing 10 in this way, it absorbs heat generated by the various parts of the motor 2 and the reduction mechanism 3 and transfers that absorbed heat to the housing 10. The heat is then released to the outside air from the outer peripheral surface of the housing 10 and cooling fins, not shown, provided on the outer peripheral surface of the housing 10, thereby cooling the overall in-wheel motor assembly 1.

Here, in the first example embodiment and modified example thereof, sponge material 31 formed of an elastic porous body is provided in an area shown in FIGS. 1 and 2 as a guide member for guiding the coolant to the gap between the stator 11 and the housing 10.

According to the structure of this example embodiment 1, even if a large force is exerted on the motor 2 such that the housing 10 greatly deforms and the gap between the stator 11 and the housing 10 is not constant, the sponge material 31 enables coolant to be uniformly guided into the gap between the stator 11 and the housing 10, thus enabling the motor 2 to be uniformly cooled. As a result, good cooling performance can be ensured.

Incidentally, the gap between the stator 11 and the housing 10 refers to a gap in either one or both of the axial direction and the radial direction. That is, the sponge material 31 may be provided only a gap in the axial direction as shown in FIG. 1 (i.e., the first example embodiment), or in both a gap in the axial direction and a gap in the radial direction as shown in FIG. 2 (i.e., the modified example of the first example embodiment). The determination of whether to provide the sponge material 31 in only one gap or in both gaps may be made appropriately depending on which part of the motor 2 exhibits a large rise in temperature.

Also, the multiple holes of the sponge material 31 serve to temporarily retain coolant. As a result, coolant that has been guided to the gap between the stator 11 and the housing 10 is temporarily retained and thus prevented from instantly running down into the reservoir 28 at the bottom of the housing 10 from gravitational force and the force acting on the motor 2. As a result, the coolant is able to effectively remove heat from the housing 10 and the stator 11, thus increasing the cooling performance of the motor 2.

Also, even if the gap between the housing 10 and the stator 11 is not constant due to the dimension tolerance of the housing 10 and the stator 11, the sponge material 31 can be interposed in the gap and the unevenness of the gap absorbed by the elasticity of the sponge material 31. The coolant guiding action of sponge material 31 interposed in the gap in this way enables the coolant to be uniformly guided into the gap between the stator 11 and the housing 10, thus enabling the motor 2 to be cooled uniformly. As a result, good cooling performance can be ensured.

Furthermore, the elasticity of the sponge material 31 suppresses deformation of the housing 10 or suppresses the stator 11 from moving relative to the housing 10 even if a large force is exerted on the motor 2. As a result, interference between the housing 10 and the stator 11 can be prevented which enables the deformation strength required of the housing 10 to be reduced, thereby reducing the weight of the housing 10, which in turn reduces the overall weight of the motor 2.

Also, interference between the housing 10 and the stator 11 damages the stator 11, and more particularly the coil 12, so providing the sponge material 31 also prevents a decline in the performance of the motor 2. Moreover, the stator 11, and more particularly the coil 12, does not have to be as strong so the stator 11 can be made smaller and lighter which enables manufacturing costs to be reduced.

In addition, the elasticity of the sponge material 31 can absorb the dimension tolerance of the housing 10 and the stator 11. As a result, the dimension tolerance allowed for the housing 10 and the stator 11 is relaxed which increases productivity of the housing 10 and the stator 11 and reduces manufacturing costs.

### Second Example Embodiment

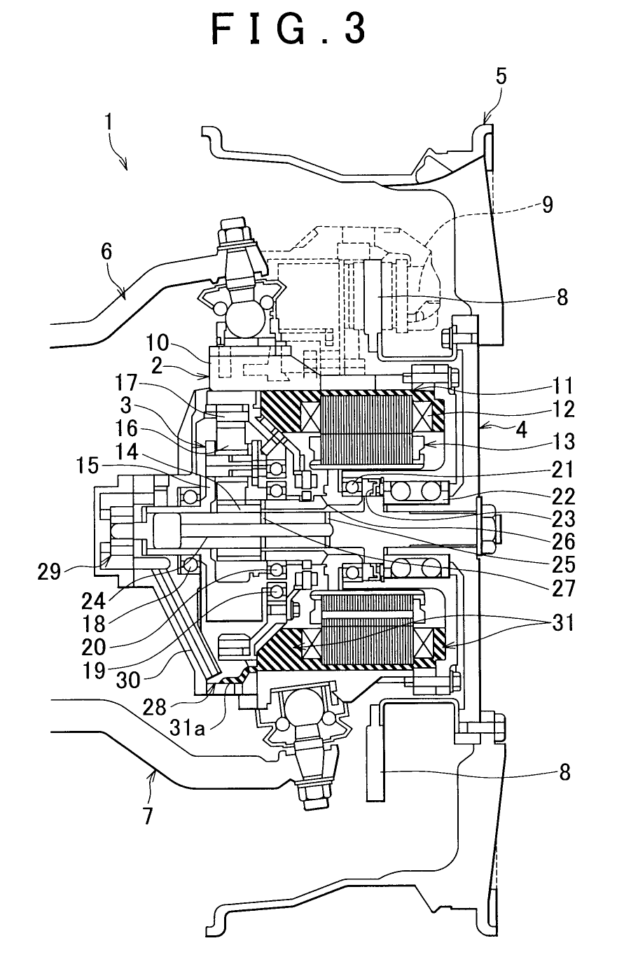

Adding the following structure to the structure described in the first example embodiment or the modified example of the first example embodiment stabilizes the behavior of the coolant in the reservoir 28. This structure will hereinafter be referred to as a second example embodiment. FIG. 3 is a sectional view of an in-wheel motor assembly to which an motor according to the second example embodiment of the invention is applied. This sectional view includes the center axis of the motor.

Incidentally, the basic structures of the in-wheel motor assembly 1 and the motor 2 are the same as those shown in FIG. 2 so common constituent elements will be denoted by the same reference numerals and redundant descriptions will be omitted.

As shown in FIG. 3, the motor 2 according to this second example embodiment is provided with an extended portion 31a in which a portion of the sponge material 31 on the inside in the vehicle width direction extends to inside the reservoir 28.

According to this structure, in addition to the effects described in the first example embodiment, the holes in the extended portion 31a of the sponge material 31 temporarily retain coolant which prevents the coolant in the reservoir 28 from suddenly shifting or noise from being produced by coolant splashing due to the entire motor 2 vibrating even if a large force is exerted on the motor 2. In addition, air is prevented from mixing with the coolant, thus preventing air from being drawn into the pump 29 that makes up part of the cooling system of the in-wheel motor assembly 1.

### Third Example Embodiment

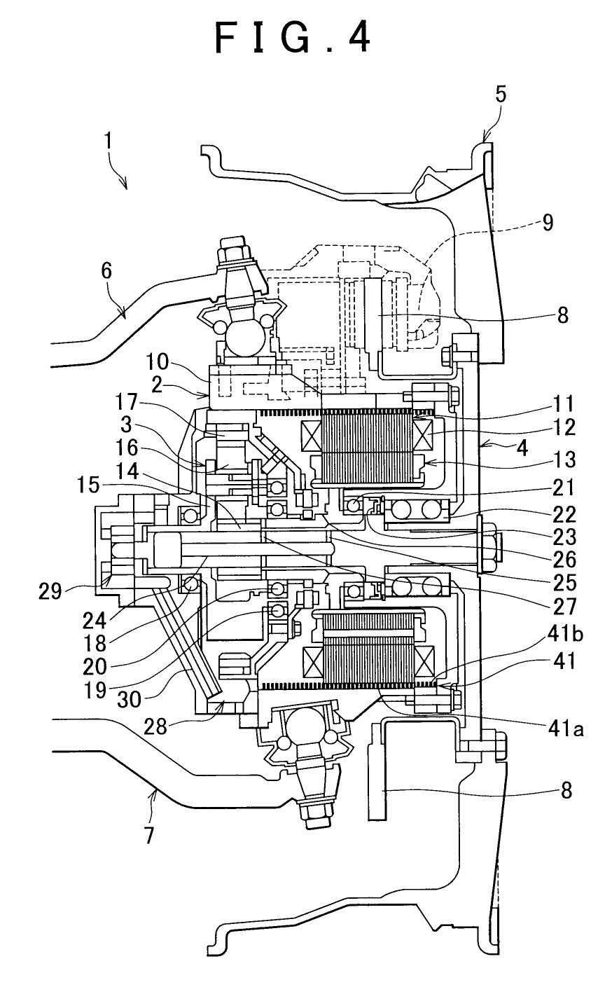

In the foregoing first and second example embodiments, the sponge material 31 is used as the guide member for guiding the coolant to the gap between the stator 11 and the housing 10. Alternatively, another mode such as that described below can also be used. A third example embodiment describing this mode will hereinafter be described. FIG. 4 is a sectional view of an in-wheel motor assembly to which a motor according to the third example embodiment of the invention has been applied. This sectional view includes the center axis of the motor.

Incidentally, the basic structures of the in-wheel motor assembly 1 and the motor 2 are the same as those shown in FIGS. 1 and 2 so common constituent elements will be denoted by the same reference numerals and redundant descriptions will be omitted.

As shown in FIG. 4, in the motor 2 according to the third example embodiment, a flocked sheet 41 is provided on the inner peripheral surface of the housing 10 as a flocked member that forms the guide member. The flocked sheet 41 is a sheet 41a made of synthetic resin that has short hairs 41b on it that are also made of synthetic resin like a brush.

According to this structure, even if the housing 10 greatly deforms such that the gap between the stator 11 and the housing 10 is not constant, the plurality of hairs 41b provided on the flocked sheet 41 guide the coolant so that it flows into the gap between the stator 11 and the housing 10. As a result, the motor 2 is able to be cooled uniformly, thereby ensuring good cooling performance.

Also, similar to the sponge material 31, the flocked sheet 41 too temporarily retains coolant by the plurality of hairs 41b on it. As a result, the coolant guided to the gap between the stator 11 and the housing 10 is temporarily retained and thus prevented from instantly running down into the reservoir 28 at the bottom of the housing 10 from gravitational force and the force acting on the motor 2. As a result, the coolant is able to effectively remove heat from the housing 10 and the stator 11, thus improving cooling performance.

Also, even if the gap between the housing 10 and the stator 11 is not constant due to the dimension tolerance of the housing 10 and the stator 11, the flocked sheet 41 can be interposed in the gap and the unevenness of the gap absorbed by the elasticity of the flocked sheet 41. As a result, the coolant can be uniformly guided into the gap between the stator 11 and the housing 10, thus enabling the motor 2 to be cooled uniformly. As a result, good cooling performance of the motor 2 can be ensured.

Furthermore, the elasticity of the flocked sheet 41 suppresses deformation of the housing 10 or suppresses the stator 11 from moving relative to the housing 10 even if a large force is exerted on the motor 2. As a result, interference between the housing 10 and the stator 11 can be prevented which enables the deformation strength required of the housing 10 in particular to be reduced, thereby reducing the weight of the housing 10, which in turn reduces the overall weight of the motor 2.

Also, interference between the housing 10 and the stator 11, more particularly the coil 12, damages the stator 11 so providing the flocked sheet 41 also prevents a decline in the performance of the motor 2. Moreover, the stator 11 does not have to be as strong so it can be made smaller and lighter which enables manufacturing costs to be reduced.

In addition, the elasticity of the flocked sheet 41 can absorb the dimension tolerance of the housing 10 and the stator 11. As a result, the dimension tolerance allowed for the housing 10 and the stator 11 is relaxed which increases productivity of the housing 10 and the stator 11 and reduces manufacturing costs of the overall motor 2.

Incidentally, using the flocked sheet 41 for the guide member as described in the third example embodiment enables the following effects to be obtained as compared with when the sponge material 31 is used as the guide member as described in the first and second example embodiments.

That is, the flocked sheet 41 is only provided on the inner peripheral surface of the housing 10. As a result, the number of work hours required to assemble the stator 11 to the housing 10 can be reduced which improves productivity of the motor 2 compared with the structures described in the first and second example embodiments. Also, compared to the sponge material 31, with the flocked sheet 41, clogging due to foreign matter and particles from wear that have mixed in with the coolant can be suppressed. Also, in the unlikely event that clogging does occur, the foreign matter and particles from wear can easily be removed.

### Fourth Example Embodiment

In the foregoing third example embodiment, the flocked sheet 41 is used as the guide member for guiding coolant into the gap between the stator 11 and the housing 10. Alternatively, another mode such as that described below can also be used. A fourth example embodiment describing this mode will hereinafter be described.

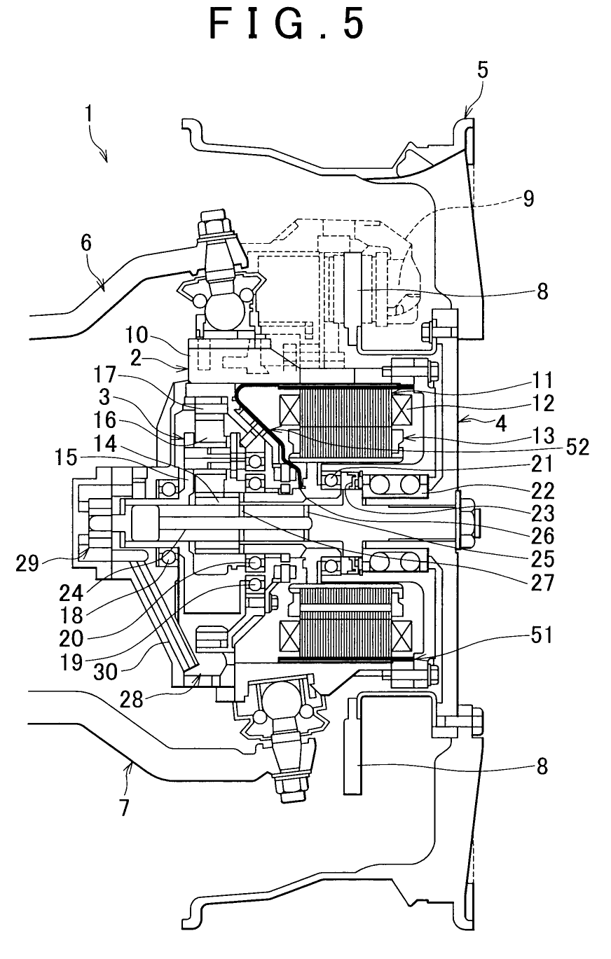

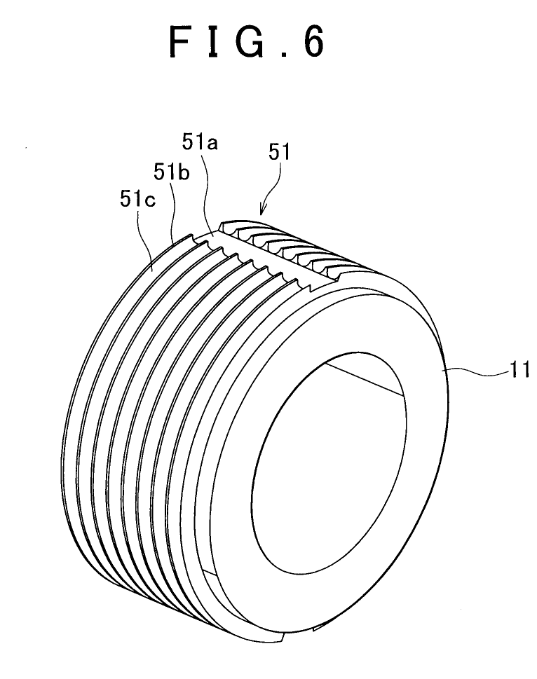

FIG. 5 is a sectional view of an in-wheel motor assembly to which a motor according to the fourth example embodiment of the invention has been applied. This sectional view includes the center axis of the motor. FIG. 6 is an enlarged view of a portion of the motor according to the fourth example embodiment.

Incidentally, the basic structures of the in-wheel motor assembly 1 and the motor 2 are the same as those shown in FIGS. 1 and 2 so common constituent elements will be denoted by the same reference numerals and redundant descriptions will be omitted.

As shown in FIG. 5, in the fourth example embodiment, the guide member that guides the coolant into the gap between the stator 11 and the housing 10 is made of a cylindrical synthetic resin body 51. Incidentally, this synthetic resin body 51 is integrally formed with the outer peripheral surface side of the stator 11 by mold casting, and has a groove portion 51a for guiding coolant which extends in the axial direction formed in the upper portion of the outer peripheral surface opposing the housing 10 as shown in FIG. 6. Also as shown in FIG. 6, the synthetic resin body 51 also has a plurality of rows of wall portions 51b which extend on both sides in the circumferential direction from the groove portion 51a, as well as groove portions 51c that extend in the circumferential direction and are formed between the wall portions 51b.

Furthermore, the motor 2 of this fourth example embodiment is formed by making the outer diameters of the wall portions 51b larger than the inner diameter of the housing 10 and inserting the stator 11 and the synthetic resin body 51 into the housing 10. Incidentally, in the fourth example embodiment, a pipe 52 is provided for collectively supplying coolant, which has been supplied from the supply passage 27 to the outer peripheral side through the inner wall on the inside in the vehicle width direction of the housing 10, to the groove portion 51a, as shown in FIG. 5.

According to this structure as well, even if a large force is exerted on the motor 2 such that the housing 10 greatly deforms and the gap between the stator 11 and the housing 10 is not constant, the guide member formed by the groove portion 51a and the groove portions 51c of the synthetic resin body 51 enables coolant to be uniformly guided into the gap between the stator 11 and the housing 10, thus enabling the motor 2 to be uniformly cooled. As a result, good cooling performance can be ensured. Incidentally, the gap between the stator 11 and the housing 10 in this case refers in particular to the gap in the radial direction.

Also, the synthetic resin body 51 has a plurality of rows of groove portions 51c formed in it. The shape effect of those groove portions 51c causes them to temporarily retain coolant. As a result, coolant that has been guided to the gap between the stator 11 and the housing 10 is temporarily retained and thus prevented from instantly running down into the reservoir 28 at the bottom of the housing 10 from gravitational force and the force acting on the motor 2. As a result, the coolant is able to effectively remove heat from the housing 10 and the stator 11, thus improving the cooling performance.

Also, even if the gap between the housing 10 and the stator 11 is not constant due to the dimension tolerance of the housing 10 and the stator 11, the cylindrical synthetic resin body 51 can be interposed in the gap and the unevenness of the gap absorbed by the elasticity of the cylindrical synthetic resin body 51, or more specifically the wall portion 51b. Accordingly, the coolant can be uniformly guided into the gap between the stator 11 and the housing 10, thus enabling the motor 2 to be cooled uniformly. As a result, good cooling performance can be ensured.

Furthermore, the elasticity of the synthetic resin body 51 suppresses deformation of the housing 10 or suppresses the stator 11 from moving relative to the housing 10 even if a large force is exerted on the motor 2. As a result, interference between the housing 10 and the stator 11 can be prevented which enables the deformation strength required of the housing 10 in particular to be reduced, thereby reducing the weight of the housing 10.

Also, interference between the housing 10 and the stator 11 damages the stator 11, and more particularly the coil 12, so providing the synthetic resin body 51 also prevents a decline in the performance of the motor 2. Moreover, the stator 11 does not have to be as strong so it can be made smaller and lighter which enables manufacturing costs to be reduced.

In addition, the elasticity of the synthetic resin body 51 can absorb the dimension tolerance of the housing 10 and the stator 11. As a result, the dimension tolerance allowed for the housing 10 and the stator 11 is relaxed which increases productivity of the housing 10 and the stator 11 and reduces manufacturing costs.

As described in the fourth example embodiment, using the synthetic resin body 51 for the guide member enables the guide member to be integrally formed with the stator 11 by mold casting which improves productivity compared with when the guide member is formed by the sponge material 31 in the first and second example embodiments or the flocked sheet 41 in the third example embodiment.

Also, by appropriately selecting the direction and number of groove portions 51a and 51c provided on the outer peripheral surface of the synthetic resin body 51, the direction in which the coolant is guided can be set freely. As a result, it is possible to concentratively guide coolant to specific areas that were discovered in advance through simulation or actual measurements to be subject to severe temperatures.

While example embodiments of the invention have been illustrated above, it is to be understood that the invention is not limited to details of the illustrated embodiments, but may be embodied with various changes, modifications or improvements without departing from the spirit and scope of the invention.

The invention relates to a rotating electrical machine that may be applied to an in-wheel motor assembly provided with a motor and a reduction mechanism for each wheel. The rotating electrical machine according to the invention ensures better cooling performance and prevents interference between the housing and the stator, and is thus beneficial for use in various types of vehicles, such as passenger cars, trucks, and buses and the like, which use in-wheel motors. Also, in addition, the invention may also be applied to a rotating electrical machine provided in a location or area where there is large input from outside.

What is claimed is:

1. A rotating electrical machine provided with a rotor, a stator, and an encasing member that encases the rotor and the stator, comprising:
a guide member that guides coolant which cools the rotating electrical machine into a gap between the stator and the encasing member.

2. The rotating electrical machine according to claim 1, wherein the guide member is formed of an elastic body.

3. The rotating electrical machine according to claim 2, wherein the guide member is formed of an elastic porous body.

4. The rotating electrical machine according to claim 2, wherein the guide member is formed of a flocked member.

5. The rotating electrical machine according to claim 4, wherein the flocked member is formed of a flocked sheet of synthetic resin on which short hairs of synthetic resin are provided.

6. The rotating electrical machine according to claim 2, wherein the guide member is formed of a synthetic resin body having a groove portion.

7. The rotating electrical machine according to claim 6, wherein the synthetic resin body having the groove portion is provided with a groove portion that extends in an axial direction of the rotating electrical machine, a plurality of wall portions which extend in a circumferential direction, and a plurality of groove portions formed between the wall portions.

8. The rotating electrical machine according to claim 6, wherein an outer diameter of the synthetic resin body having the groove portion is larger than an inner diameter of the encasing member.

9. The rotating electrical machine according to claim 7, wherein an outer diameter of the synthetic resin body having the groove portion is larger than an inner diameter of the encasing member.

10. The rotating electrical machine according to claim 3, further comprising:
a storing portion in which the coolant is stored,
wherein a portion of the elastic porous body extends into the storing portion.

11. An in-wheel motor assembly comprising:
the rotating electrical machine according to claim 2,
wherein the rotating electrical machine is provided for each wheel of a vehicle and is arranged in a position on an inner peripheral side of a wheel assembly.
